(19) United States
(12) Patent Application Publication
(10) Pub. No.: US 2014/0229754 A1
(43) Pub. Date: Aug. 14, 2014

(54) POWER TELEMETRY REMOTE MONITORING

(71) Applicant: NVIDIA CORPORATION, Santa Clara, CA (US)

(72) Inventors: Mark A. OVERBY, Bothell, WA (US); Ratin KUMAR, Santa Clara, CA (US)

(73) Assignee: NVIDIA CORPORATION, Santa Clara, CA (US)

(21) Appl. No.: 13/764,368

(22) Filed: Feb. 11, 2013

(51) Int. Cl. G06F 11/30

(52) U.S. Cl. CPC G06F 11/3062
USPC 713/340

(57) ABSTRACT

Embodiments disclosed herein generally relate to the collection and correlation of power consumption data for mobile devices. Power consumption data for a mobile device is collected and correlated with system activity by monitoring what processes are being run on the CPU and measuring the power being consumed within the mobile device. The power being consumed within the mobile device is measured via a plurality of power monitors, such as sensors, disposed within the mobile device and buffered using an auxiliary microcontroller that resides separately from the CPU. Further, in some embodiments, temperature data also is measured via a temperature sensor.

### BACKGROUND OF THE INVENTION

1. Field of the Invention

Embodiments of the invention generally relate processing units and, more specifically to power telemetry remote monitoring.

2. Description of the Related Art

When a manufacturer designs a mobile device, the manufacturer attempts to optimize the battery usage of the mobile device by testing the battery usage under a set of controlled circumstances or particular power consumption models. For example, in a certain model, a specific video in a specific format may be played on the mobile device along with a known number and type of applications that also are simultaneously running on the mobile device. The manufacturer can then assess battery usage of the mobile device under this specific model to determine if one or more hardware elements or software programs are using an excessive or undesired amount of power. The information gathered using these models assists the manufacturer in making design choices to increase battery efficiency.

One problem, however, is that consumers do not use the mobile device under the same constrained circumstances used by the developer to determine power consumption. The models utilized by the manufacturer to determine power consumption are under-inclusive of real-world scenarios. Further, the assumptions used in these models may not even hold true in the real world. Thus, for example, because the manufacturer cannot monitor how the system is actually used by a consumer, the manufacturer cannot know which power optimization settings to apply to optimize power consumption for real-world use scenarios.

Furthermore, the inability to monitor the actual use of a mobile device makes diagnosing power consumption problems difficult for manufacturers and device suppliers and oftentimes results in a troubleshooter having to guess or extrapolate the cause of undesirable power consumption on a particular device. For example, someone troubleshooting a power issue may note that the power issues occur contemporaneously with running a particular application, causing that person to infer that the running application is responsible for the power consumption issues. However, the power consumption issues could just as likely be caused by a second application that also is running on the device or by a hardware-oriented problem within the device. Without accurate power consumption data for the mobile device, accurately diagnosing power consumption issues associated with the mobile device can be quite difficult.

As the foregoing illustrates, what is needed in the art is a better way to track and understand the power consumption behaviors of hand-held and other computing devices.

### SUMMARY OF THE INVENTION

In one embodiment, a method of monitoring power consumption in a system is disclosed. The method includes receiving time-stamped power sensor data from a first buffer of a microcontroller, correlating the time-stamped power sensor data with time-stamped CPU process data, and logging the correlated data.

One advantage of the disclosed approach is that collecting and correlating power consumption data for mobile devices is based on how the mobile devices are actually used by consumers. The collection of power data for how the mobile devices are actually being used enhances diagnostic troubleshooting of power consumption issues for those devices. Because a troubleshooter can identify which processes are running on a CPU at a given time, as well as the amount and location of power consumption within a mobile system at the same time, the troubleshooter is able to more accurately identify the cause of power consumption issues within the mobile device. The collected and correlated power consumption data enables a troubleshooter to distinguishing between software-related power consumption issues or hardware-related power consumption issues.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the invention;

FIG. 2 is a block diagram illustrating a system for measuring power consumption, according to one embodiment of the invention;

FIG. 3 is a flow diagram of method steps for buffering time-stamped power sensor data, according to one embodiment of the invention;

FIG. 4 is a flow diagram of method steps for buffering time-stamped CPU process data, according to one embodiment of the invention; and

FIG. 5 is a flow diagram of method steps for correlating and logging time-stamped power sensor data and time-stamped CPU process data, according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

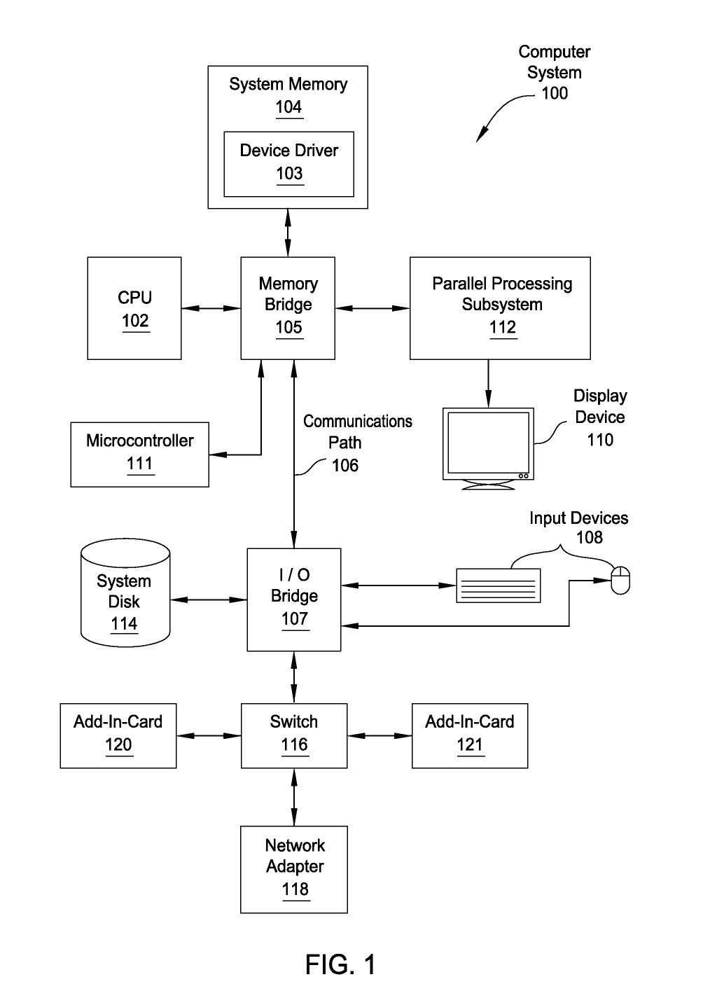

FIG. 1 is a block diagram illustrating a computer system configured to implement one or more aspects of the invention. The computer system 100 includes a central processing unit (CPU) 102 and a system memory 104 (having a device driver 103) communicating via a bus path through a memory bridge 105. The memory bridge 105 may be integrated into the CPU 102. Alternatively, the memory bridge 105, may be a conventional device, e.g., a Northbridge chip, that is coupled to the CPU 102 via a bus as shown in FIG. 1. The memory bridge 105 is also coupled to an I/O (input/output) bridge 107 via communication path 106 (e.g., a HyperTransport link).

The I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to the memory bridge 105 via a bus or other communication path 113 (e.g., a PCI Express, Accelerated Graphics Port, or HyperTransport link). In one embodiment the parallel processing subsystem 112 is a graphics subsystem that delivers pixels to a display device 110 (e.g., a conventional CRT or LCD based monitor). A system disk 114 is also connected to the I/O bridge 107. A switch 116 provides connections between the I/O bridge 107 and other components such as a network adapter 118 and various add-in cards 120 and 121. Other components (not explicitly shown), including USB or other port connections, CD drives, DVD drives, film recording devices, and the like, may also be connected to the I/O bridge 107. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture. In yet another embodiment, the parallel processing subsystem 112 may be integrated with one or more other system elements, such as the memory bridge 105, CPU 102, and I/O bridge 107 to form a system on chip (SoC).

It will be appreciated that the system shown in FIG. 1 is illustrative and that variations and modifications are possible. The connection topology, including the number and arrangement of bridges, may be modified as desired. For instance, in some embodiments, the system memory 104 is directly connected to the CPU 102 rather than connected through a bridge, and other devices communicate with the system memory 104 via the memory bridge 105 and the CPU 102. In other alternative topologies, the parallel processing subsystem 112 is connected to the I/O bridge 107 or directly to CPU 102, rather than to memory bridge 105. In still other embodiments, one or more of CPU 102, I/O bridge 107, parallel processing subsystem 112, and memory bridge 105 may be integrated into one or more chips. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

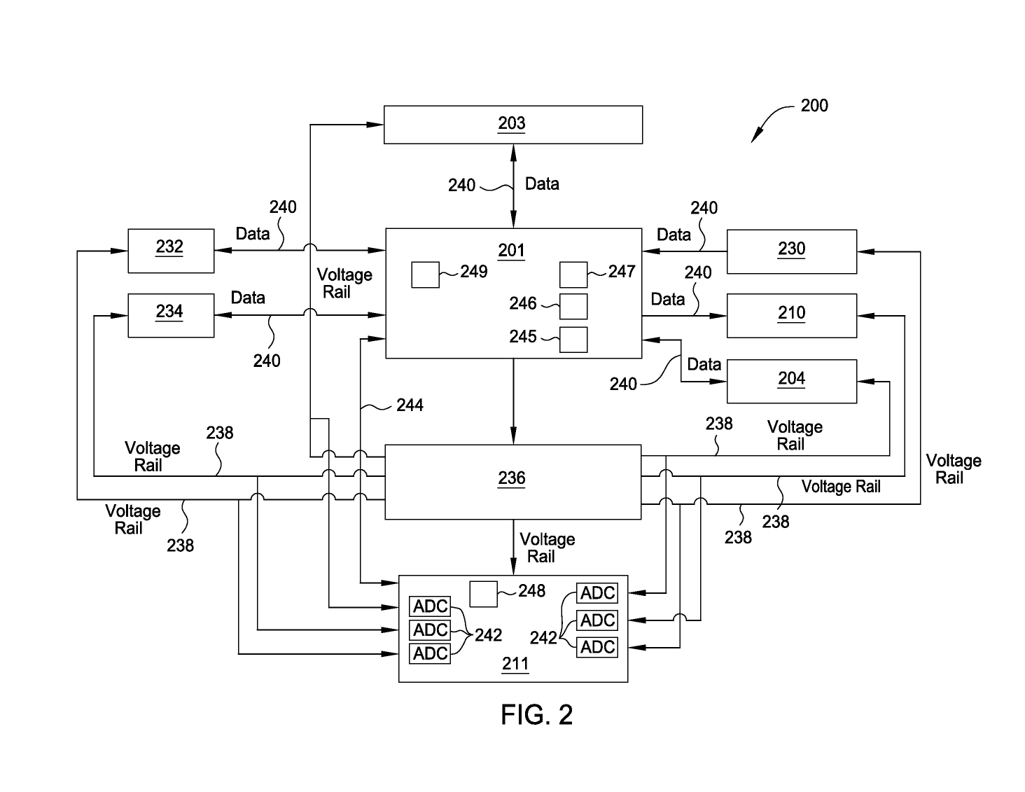

FIG. 2 is a block diagram illustrating a system 200 for measuring power consumption, according to one embodiment of the invention. The system 200 may include any and all components of the computer system 100. The system 200 includes an SoC 201 coupled to a memory 203, such as a DRAM, via a data connection 240. The connection 240 is adapted to facilitate the transfer of data between the SoC 201 and the memory 203. The system 200 also includes a WiFi chip 232, a mobile broadband chip 234, a memory 204, a display 210, and one or more sensors 230 (e.g., temperature sensors), each of which are coupled to the SoC 201 via a data connection 240. Power is supplied to each of the WiFi chip 232, the mobile broadband chip 234, the memory 204, the display 210, and the one or more sensors 230 via voltage rails 238. Voltage rails 238 are coupled to a power management integrated circuit 236 that manages the supply of power to the WiFi chip 232, the mobile broadband chip 234, the memory 204, the display 210, and the one or more sensors 230.

The SoC 201 also includes a first coalesced timer 246 and a second coalesced timer 247. The first and second coalesced timers 246 and 247 are hardware timers, and are adapted to trigger particular events within the system 200 after expiring, as explained in further detail below. Upon expiration of the first and second coalesced timers 246 and 247, the first and second coalesced timers 246 and 247 reset. It is contemplated that the time intervals of the first and second coalesced timers 246 and 247 may be equal to one another, or may be different than one another. The first and second coalesced timers 246 and 247 are adapted to operate independently.

A microcontroller 211 is coupled to each of the voltage rails 238. The microcontroller 211 includes sensors 242, such as analog-to-digital converters and/or shunt current monitors, adapted to measure the voltage along each voltage rail 238. The microcontroller 211 determines the power consumption along each voltage rail 238 using the sensed voltages, and buffers the respective power consumptions within the buffer 238 located within the microcontroller 211. The power consumption along each voltage rail 248 is indicative of the power consumption of a particular hardware component in the system 200 to which a particular voltage rail 238 is connected. While FIG. 2 illustrates the sensors 242 as located within the microcontroller 211, it is contemplated that the sensors 242 may be external to the microcontroller 211.

The sensors 242 and the microcontroller 211 consume relatively little power and are adapted to operate continuously, even when the system 200 is in a low power state. Thus, power consumption of components of the system 200 can be determined when the system 200 is in a low power state by monitoring power consumption along the voltage rails 238. The data collected by the sensors 242 is buffered in the buffer 248 by the microcontroller 211. The buffered data is stamped with a time stamp from a time stamp counter 245 operating on the SoC 201. Buffered data from the microcontroller 211 is provided to the SoC 201 via an I2C bus 244 at intervals determined by data collection software running on the SoC 201. In one embodiment, the data collection software does not operate when the system 200 is in a lower power state, and thus, only requests the time-stamped buffered power sensor data when the system 200 is operating in a normal power mode.

FIG. 2 illustrates one embodiment of a system 200; however, other embodiments are also contemplated. For example, it is contemplated that the first coalesced timer 246 and the second coalesced timer 247 may be located externally of the SoC 201. In another embodiment, it is contemplated that the first coalesced timer 246 may be located within the microcontroller 211.

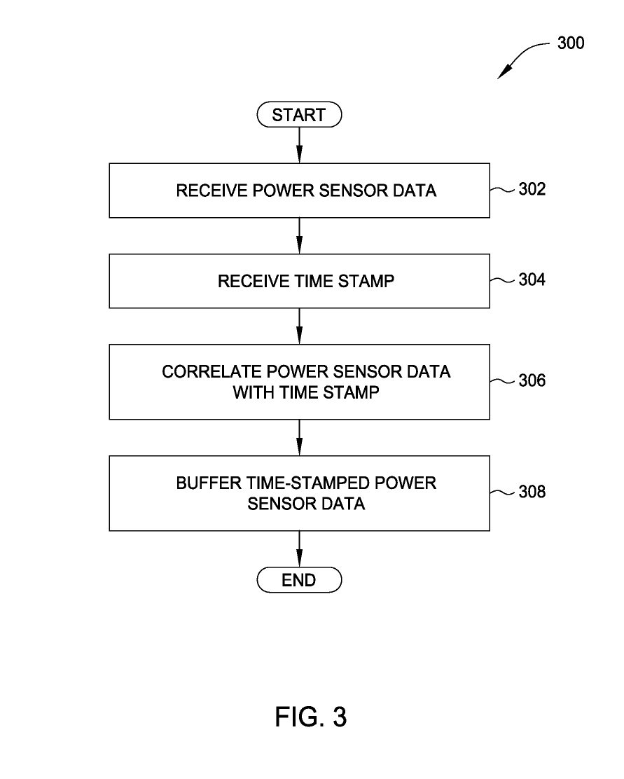

FIG. 3 is a flow diagram of method steps for buffering time-stamped power sensor data, according to one embodiment of the invention. Although the method steps are described in conjunction with FIG. 1 and FIG. 2, persons skilled in the art will understand that any system configured to perform the method steps, in any order, falls within the scope of the present invention.

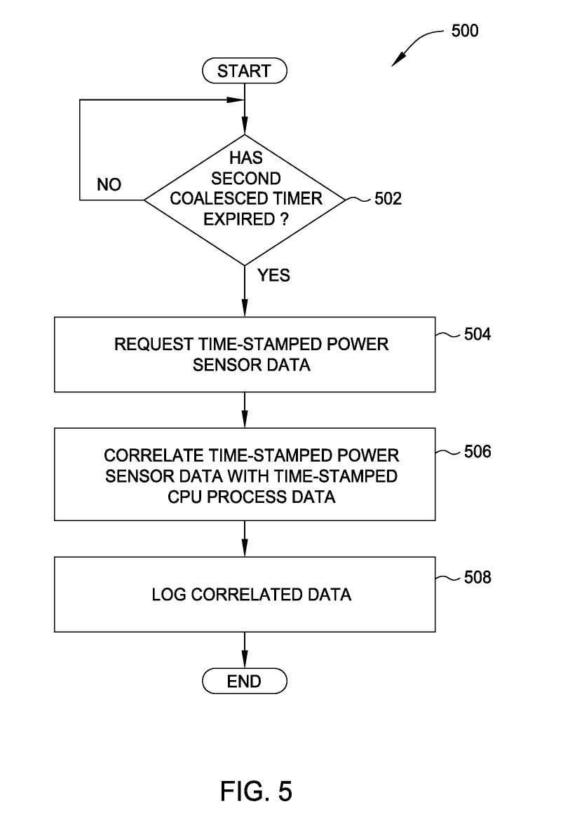

As shown, a method 300 begins at step 302, where the microcontroller 211 acquires power sensor data from the sensors 242. The power sensor data from the sensors 242 may be received by the microcontroller 211 in a substantially continuous manner, or may, for example, be received at predetermined time intervals. For example, power data may be received by the microcontroller at a frequency of about 20 Hz; however, this is only exemplary and it is to be understood that other frequencies are contemplated. After the microcontroller 211 receives the power sensor data, the microcontroller 211 requests and receives a time stamp from a time stamp counter 245 during step 304. In step 306, the microcontroller 211 correlates the received power sensor data with the time stamp received from the time stamp counter 245, and, in step 308, the microcontroller 211 buffers the time-stamped power sensor data in the buffer 248. The buffered time-stamped power data may be subsequently utilized by the system 200, as explained in more detail with respect to FIG. 5.

FIG. 3 illustrates one embodiment of how the method steps for buffering time-stamped power sensor data may be implemented; however, additional embodiments are also contemplated. In one embodiment, the microcontroller 211 operates while the system 200 is in a low power state, as well as when the system 200 is in a normal operating state. Thus, power sensor data from the power sensors 242 continues to be collected while the system 200 is in a low power state.

The continued collection of power sensor data while the system 200 is in a lower power state facilitates the identification of faulty hardware. For example, collection of power data during a low power state assists in the identification of hardware that does not enter the low power state, which may indicate that the particular hardware is faulty. Additionally, the collection of power data while the system is in a normal operating state may also facilitate the identification of faulty hardware, for example, by identifying hardware that is consuming excessive amounts of power, or by identifying hardware that is receiving or utilizing insufficient amounts of power. In addition, the collected power data facilitates the optimization of system settings and design by identifying the proportionate shares of power consumption amongst the components of the system 200. A user or a third party can optimize the power consumption within the system using the collected power consumption data by adjusting hardware design, system settings, or application settings.

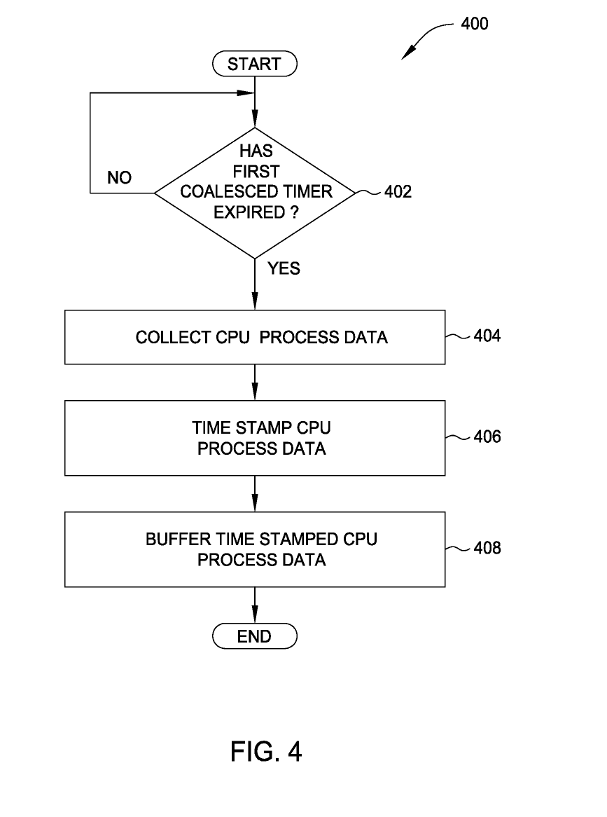

FIG. 4 is a flow diagram of method steps for buffering time-stamped CPU process data, according to one embodiment of the invention. Although the method steps are described in conjunction with FIGS. 1-2, persons skilled in the art will understand that any system configured to perform the method steps, in any order, falls within the scope of the present invention.

As shown, a method 400 begins at step 402, in which a first thread executing on the CPU 102 determines whether the first coalesced timer 246 has expired. If the first coalesced timer 246 has not expired, the first thread repeats step 402. Upon expiration of the first coalesced time, the first thread proceeds to step 404 and collects CPU process data, and the first coalesced timer resets. The CPU process data includes the number of CPUs currently operating, which processes are currently running on the CPUs, process run time, the number of threads of each process, the clock rate of the CPUs, and the like. In step 406, the first thread correlates the CPU process data with a time stamp using a time received from the time stamp counter 245. In step 408, the time-stamped CPU process data is buffered in the buffer 249 by the first thread.

FIG. 4 illustrates one embodiment of buffering time-stamped CPU process data; however, additional embodiments are also contemplated. In another embodiment, the first thread may also collect temperature data of the system 200 during step 404. For example, the software application may collect data related to the temperature of the CPU 102. The temperature data can also be time stamped and buffered in the buffer 249. The temperature data may be received from one of the sensors 230 that is adapted to measure the temperature of a particular component of the system 200.

In another embodiment, it is contemplated that the first thread described with respect to FIG. 4 does not execute when the system 200 is in a low power state. For example, if the first coalesced timer expires while the system 200 is in a lower power state, step 402-408 may be suspended until the system 200 resumes a normal operating state. In this manner, the system 200 is not awakened from a low power state to execute the first thread. Additionally, in such an embodiment, it is contemplated that the first coalesced timer may not reset until the system 200 resumes a normal operating state.

FIG. 5 is a flow diagram of method steps for correlating and logging time-stamped power sensor data and time-stamped CPU process data, according to one embodiment of the invention. Although the method steps are described in conjunction with FIGS. 1-2, persons skilled in the art will understand that any system configured to perform the method steps, in any order, falls within the scope of the present invention.

As shown, a method 500 begins at step 502, where a second thread executing on the CPU 102 determines whether the second coalesced timer 247 has expired. If the second coalesced timer 247 has not expired, the second thread repeats step 502. Upon expiration of the second coalesced time, the second thread proceeds to step 504 and requests the time-stamped power sensor data from the buffer 248, and the second coalesced timer resets. The time-stamped power sensor data from the buffer 248 is transferred to the SoC 201 via the I2C bus 244. In step 506, the second thread correlates (e.g., aligns) the time-stamped power sensor data with the time-stamped CPU process data using the time stamps of the respective data. Thus, the correlated data provides accurate system information regarding the power consumption of the system 200 as the power consumption relates to specific processes executing on the CPU 102 at any instant in time. Particularly, the correlated time-stamped data facilitates the identification of hardware power consumption as the power consumption relates to the processes executing on the CPU 102.

In step 508, the correlated data from step 506 (e.g., the time-stamped power sensor data and the time-stamped CPU process data) is logged and stored by the second thread. The log may be stored, for example, in a memory such as system memory 104. The log may be accessible to a system user or to a third party (e.g., a hardware manufacturer or a software programmer) for trouble shooting, diagnostic, or design/improvement purposes. It is contemplated that the log may be provided over a network to a third party, or accessed locally on the system 100. The log provides a thorough overview of power consumption on the system 200 for components of the system 200 as the power consumption relates the processes executing on the CPU 102. The log facilitates the improvement of power consumption on the system 200, and the identification of power-related issues on the system 200, particularly because the log is generated from data of the system 200 under actual usage conditions of the system 200. The log may be provided to a third party hardware or application developer to facilitate the developer's understanding of power consumption on the system 200 as the system is utilized by a user under actual usage conditions. Thus, the log can be used to inform future design choices for the system 200 and applications that run thereon.

FIG. 5 illustrates one embodiment of how the method steps for correlating and logging time-stamped power sensor data and time-stamped CPU process data may be implemented, however, additional embodiments are also contemplated. For example, it is contemplated that if time-stamped temperature data has been collected, the time-stamped temperature data may also be logged in step 508. In such an embodiment, the temperature data would also be correlated in step 506.

In another embodiment, it is contemplated that the second thread described with respect to FIG. 5 does not execute when the system 200 is in a low power state. For example, if the second coalesced timer expires while the system 200 is in a lower power state, step 502-508 may be suspended until the system 200 resumes a normal operating state. In this manner, the system 200 is not awakened from a low power state to execute the second thread. Additionally, in such an embodiment, it is contemplated that the second coalesced timer may not reset until the system 200 resumes a normal operating state.

In sum, power consumption data for a mobile device is collected and correlated with system activity by monitoring what processes are being run on the CPU and measuring the power being consumed within the mobile device. The power being consumed within the mobile device is measured via a plurality of power monitors, such as sensors, disposed within the mobile device and buffered using an auxiliary microcontroller that resides separately from the CPU. Further, in some embodiments, temperature data also is measured via a temperature sensor.

During normal CPU operation, a first thread executing on the CPU records which processes are running on the CPU and the length of time these processes have been running. The first thread also time stamps this recorded information. The first thread for recording CPU processes executes at the expiration of a first coalesced timer. The auxiliary microcontroller obtains readings from the power and temperature sensors at predetermined intervals and buffers the obtained power and temperature data. The auxiliary microcontroller also time stamps the buffered data. In one embodiment, the power sensors are current or voltage sensors that are positioned within the mobile device to measure electrical current or voltage along power rails that provide power to various components of the mobile device.

A second thread executing on the CPU correlates the recorded information obtained by the first thread with the recorded power sensor data and temperature data, and logs the correlated information. The CPU requests the data buffered by the auxiliary microcontroller and correlates the requested data with the information obtained by the first thread according to the respective time stamps. The second thread executes at the expiration of a second coalesced timer.

When the CPU is powered down or turned off, the power sensors continue to operate, thereby allowing power consumption data to be tracked even when the CPU is in a standby mode. Power consumption data can be tracked when the CPU is powered down because the auxiliary microcontroller resides separately from the CPU, and thus, enables data buffering even when the CPU is powered down or turned off. If the first coalesced timer for the first thread or the second coalesced timer for the second thread expires while the CPU is powered down or turned off, the execution of the respective first thread and/or the second thread is suspended until the CPU is powered on or otherwise resumes a normal operating state. While embodiments herein are described with respect to a CPU, it is contemplated that operations need not be performed on a CPU, and may instead be performed on another processing unit.

One advantage of the disclosed approach is that it enables power consumption data for a mobile device to be collected and correlated based on how the mobile device is actually being used. The power consumption data under actual use facilitates the design of accurate power optimization settings for the mobile device. Additionally, the collection of power data based on how a mobile device is actually being used enhances diagnostic troubleshooting of power consumption issues for the mobile device. For example, data collected using the disclosed approach allows a troubleshooter to identify which processes are running on a CPU during a given period of time, the amount of power being consumed by the mobile device during that period of time, and where within the mobile device power is being consumed during that period of time. With this information, a troubleshooter can more easily and accurately identify the cause of power consumption issues within the mobile device, including whether the cause is software or hardware related.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

Therefore, the scope of the present invention is determined by the claims that follow.

We claim:

1. A computer-implemented method for monitoring power consumption in a system, the method comprising:
receiving time-stamped power sensor data from a first buffer of a microcontroller;
correlating the time-stamped power sensor data with time-stamped process data; and
logging the correlated data.

2. The method of claim 1, wherein the time-stamped power sensor data includes power measurement data associated with voltage rails within the system.

3. The method of claim 1, further comprising collecting, by a first thread, the time-stamped process data, wherein the time-stamped process data includes data related to processes operating on a processing unit.

4. The method of claim 3, further comprising collecting the process data at the expiration of a first coalesced timer.

5. The method of claim 4, wherein receiving, the correlating, and the logging occur at the expiration of a second coalesced timer.

6. The method of claim 1, further comprising:
receiving time-stamped temperature data; and
correlating the time-stamped temperature data with the time-stamped power sensor data and the time-stamped process data.

7. The method of claim 1, further comprising collecting the time-stamped power sensor data while the system is in a low power state.

8. A non-transitory computer-readable medium including instructions, that, when executed by a processing unit of a system, cause the system to monitoring power consumption in the system by performing the steps of:
receiving time-stamped power sensor data from a first buffer of a microcontroller;
correlating the time-stamped power sensor data with time-stamped processing unit process data; and
logging the correlated data.

9. The non-transitory computer-readable medium of claim 8, wherein the time-stamped power sensor data includes power measurements along voltage rails within the system.

10. The non-transitory computer-readable medium of claim 8, wherein the time-stamped processing unit process data includes data collected by a first thread executing on the processing unit.

11. The non-transitory computer-readable medium of claim 10, wherein the processing unit process data is collected at the expiration of a first coalesced timer.

12. The non-transitory computer-readable medium of claim 11, wherein receiving, correlating, and logging occur at the expiration of a second coalesced timer.

13. The non-transitory computer-readable medium of claim 8, further comprising:
receiving time-stamped temperature data; and
correlating the time-stamped temperature data with the time-stamped power sensor data and the time-stamped processing unit process data.

14. The non-transitory computer-readable medium of claim 8, wherein the time-stamped power sensor data is collected.

15. A system for monitoring power consumption, comprising:
a processing unit;
a first coalesced timer;
a second coalesced timer;
a microcontroller; and
a memory storing instructions that, when executed by the processing unit, cause the processing unit to perform the steps of:
receiving time-stamped power sensor data from a first buffer of the microcontroller;
correlating the time-stamped power sensor data with time-stamped process data; and
logging the correlated data.

16. The system of claim 15, further comprising voltage rails having sensors coupled thereto, each sensor adapted to measure a voltage along one of the voltage rails.

17. The system of claim 16, wherein the microcontroller is adapted to receive voltage measurements from the sensors.

18. The system of claim 15, wherein receiving, correlating, and logging occur at the expiration of the second coalesced timer.

19. The system of claim 15, wherein the time-stamped power sensor data is collected while the system is in a low power state

20. The system of claim 15, wherein the process data is collected at the expiration of a first coalesced timer.
